(19) United States
(12) Patent Application Publication
(10) Pub. No.: US 2006/0101145 A1
(43) Pub. Date: May 11, 2006

(54) Method for running servers behind firewalls, routers, proxy servers and network address translation software and devices

(76) Inventors: James Hoffman, Woodstock, NY (US); James Friskel, Rockledge, FL (US)

Correspondence Address: NIELDS & LEMACK, 176 EAST MAIN STREET, SUITE 7, WESTBORO, MA, 01581, US

(21) Appl. No.: 10/530,111

(22) PCT Filed: Oct. 2, 2003
(86) PCT No.: PCT/US03/31333

§ 371 Date: Sep. 2, 2005

Related U.S. Application Data
(60) Provisional application No. 60/416,185, filed on Oct. 4, 2002.

(51) Int. Cl. G06F 15/16

(52) U.S. Cl. 709/227

(57) ABSTRACT

The present invention provides a system and method for automatically and securely enabling a server to be accessed by systems and devices under conditions where it would otherwise be inaccessible. Servers maintain higher levels of security as listening ports are not utilized in the invention. The methods described allow access between devices, even in the presence of firewalls, proxy servers and NAT devices.

This application claims the benefit of domestic priority based on provisional application, 60/416,185, filed Oct. 4, 2002, entitled “Method for Running Servers Behind Firewalls, Routers, Proxy Servers and Network Address Translation Software and Devices”, submitted by Woodstock Systems, LLC, f/k/a MediaStor, LLC, the disclosure of which is hereby incorporated by reference.

### FIELD OF THE INVENTION

The present invention relates to computer networks, and in particular the ability of a server to access a receiving communications port despite certain system/infrastructure issues that might otherwise prevent such access.

### BACKGROUND OF THE INVENTION

With the advances of computer information systems, individuals and businesses around the world regularly provide remote access to a computer or device. Increasingly, this access is complicated by firewalls, routers, proxy servers and NAT (Network Address Translation) mediation. These network devices and software, either by design or unintentionally, block or reassign ports and Internet Protocol (IP) addresses, thereby preventing an external computer or device from accessing a computer or device that is on a network equipped with such devices or software.

A typical Web server application or device serves data to a computer connected to the server's “Listening port”. This port must be accessible to the server, or the server would never receive the computer's request. Firewalls, routers, proxy servers and NAT devices can all impair or eliminate a server's ability to locate an accessible port. This creates significant problems for businesses and consumers. The current solution to these problems involves extremely complicated configuration setting of the blocking firewall, router, proxy server or NAT device, and in many cases, a solution does not currently exist. The need for simple methods that will automatically and securely provide this type of access is critical for many current and future uses, both at work and at home.

More specifically, in conventional computer networks today, computers require a port to be semi-permanently configured to allow incoming traffic that is not in direct conjunction with a previous outbound communication to pass through. These ports are referred to as “listening ports” and allow computers to detect network communication that is intended for them. These ports are publicly visible and any other computer on the network can attach to these ports. While this is intended to allow a simple method of having 2 computers, previously unknown to each other, communicate; there are a number of drawbacks in this scheme. Publicly visible ports are vulnerable to attack by other (e.g. unauthorized) computers. Denial of Service attacks, where another computer constantly sends messages to the computer in an attempt to deplete its resources, are one such problem. Another security issue is “worm-like” software trolling IP addresses on the network looking for public listening ports to attack. To counteract these attacks, a number of security protocols and devices have been devised, such as firewalls. These devices reduce the risk of such an attack, but make the allowable access to a computer more difficult. For example, a firewall may allow all incoming traffic or restrict it to allow only certain IP addresses to access the computer network behind it. A set of users may wish to set up a share group, where they can view certain files on each other's computers. When an unknown computer, wishing to join the share group with no malicious intent, attempts to access a computer behind the firewall to access some shareable files, that access will be denied by the firewall. This makes the process of creating share groups very difficult, as the firewall would need to be reconfigured each time a new member joins the share group. Similarly, Network Translation devices (NAT devices) address the security issue by opening the port only for one computer to communicate. Present systems force users to choose between tight security with minimal or difficult sharing capabilities, or full sharing capabilities with minimal or no security.

### SUMMARY OF THE INVENTION

The present invention overcomes the current shortcomings in the prior art by providing a system and method for automatically and securely enabling a server to be accessed by systems and devices under conditions where it would otherwise be inaccessible, or where accessibility would be difficult. The present invention has particular applicability in connection with the Personal Digital Server (“PDS”), a computer application for the storage, updating, management and sharing of all types of digital media files, including audio, video, images and documents, irrespective of their format. A Patent Application for PDS, entitled “Personal Digital Server™ (PDS™)”, application number PCT/US 02/41403 was filed by Woodstock Systems, LLC, f/k/a MediaStor, LLC on Dec. 24, 2002 and is hereby incorporated by reference.

### BRIEF DESCRIPTION OF THE DRAWINGS

FIG. 1 illustrates an exemplary embodiment of a computer network system and a method for setting up a computer server as a non-listening server according to the present invention;

FIG. 2 illustrates an exemplary embodiment of initiation of client request to a server in the “Non Listening Server” mode in the computer network system of FIG. 1 according to the present invention;

FIG. 3 illustrates an exemplary embodiment of the status of the computer network system shown in FIG. 1 when the server is acting as a “Just-in-Time Listening Server” in waiting mode according to the present invention; and

FIG. 4 illustrates an exemplary embodiment of a client request when the server is acting as a “Just-In-Time Listening Server”.

### DETAILED DESCRIPTION OF THE INVENTION

The present invention allows a server application or device to share files and other media with other computers in a secure and simple method. Two approaches to this are disclosed. One is referred to as “just-in-time-listening (JITL)” mode. The second approach, known as “Non-Listening Server (NLS)” mode can be employed particularly when tighter security constraints are desired.

The Non-Listening Server (NLS)

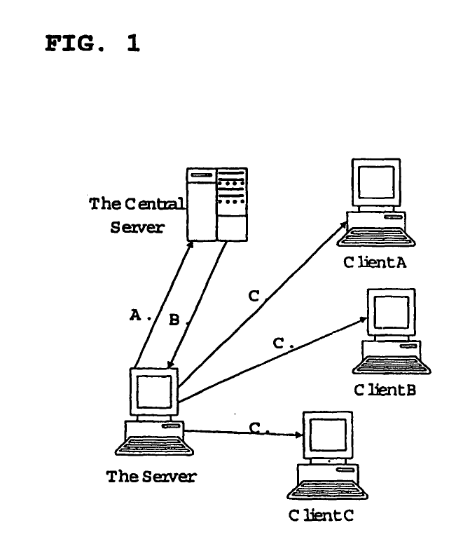

A software application can operate on a server without a publicly visible “listening” port when utilizing the Non-Listening Server (NLS) method. This method is shown in FIG. 1. In Step A, the server 10 securely connects itself to a central administrative node 20. The central server preferably always has a listening node. The security of the central administrative node is maintained preferably by limiting the software applications resident on the node to a minimum, most preferably to only this application. Access to the central administrative node 20 can be achieved by methods well known in the art. For example, a fixed IP address may be used, or more preferably, a domain name, such as for example http://registration.WoodstockSystems.com, the identity of which server 10 is aware. The server can be located behind a firewall, proxy server, router or Network Address Translation device. Since the server is the device initiating the transaction, it is able to access the central node without issue. In Step B, in response to a request by the connected server, the central administrative node supplies the current IP address of users, systems and devices (collectively, “Clients”) that are authorized to access that specific server. Since the list of authorized users can be a dynamic entity, this list can be continuously updated at the server. This can be done in a number of ways, including having the server query the central administrative node at regular intervals, having the central node notify the server of any changes to the list, or maintaining a persistent connection to the central node and receiving these updates in real time. Other suitable update methods are available and are well known in the art.

In the “Non Listening Server” mode, the server does not have any open listening ports; therefore clients are unable to connect directly to the server. Instead, as shown in step C, the server securely connects itself directly to each of the authorized Clients, 30a, 30b and 30c, as identified by the central administrative node, via its own outbound messaging. It will be understood by those skilled in the art that although three authorized clients are shown, there could be any number of clients without departing from the spirit and scope of the preset invention. In this way, a secure communications path is established between the server and each of its authorized clients.

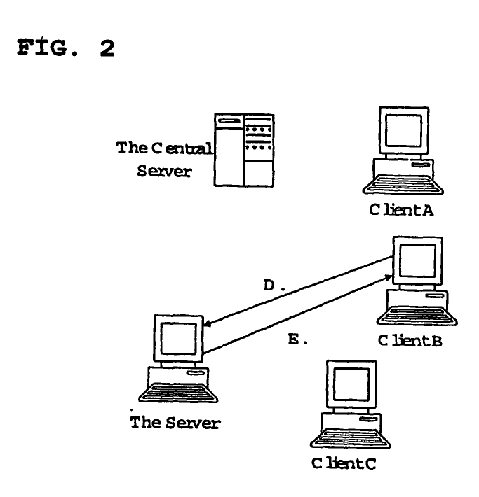

FIG. 2 illustrates, in step D, the scenario where a client 30b can request specific data from the server 10 using the open connection established previously by the server in FIG. 1. In step E, the server 10 can then serve the data to the requesting Client 30b using the open connection. Steps D and E can then be repeated each time that the client requests information from the server.

In this embodiment, the server never opens up an externally available ‘listening’ port, so the security risk of rogue software targeting TCP/IP ‘listening’ ports is eliminated. All communication occurs during sessions that that server itself initiated. This eliminates the possibility of a denial-of-service attack on the server and also eliminates the possibility of any ‘worm-like’ software trolling IP addresses for ‘listening’ ports.

The server in Non-Listening Server (NLS) mode can operate behind the most stringent firewalls when it makes an outside connection to the Internet, as shown in FIG. 1. However, it is noted in this method that a server running in NLS mode cannot communicate with Clients that are also behind a firewall.

Additional levels of security can be added to the NLS scenario via encryption technology if desired. For example, the messages exchanged in the NLS mode can be encrypted, using algorithms and technologies that are known by those skilled in the art.

The Just-In-Time Listening (JITL)

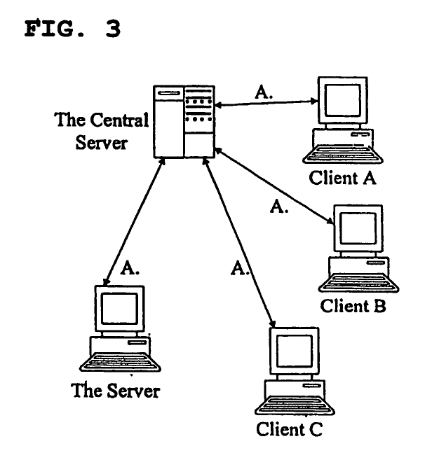

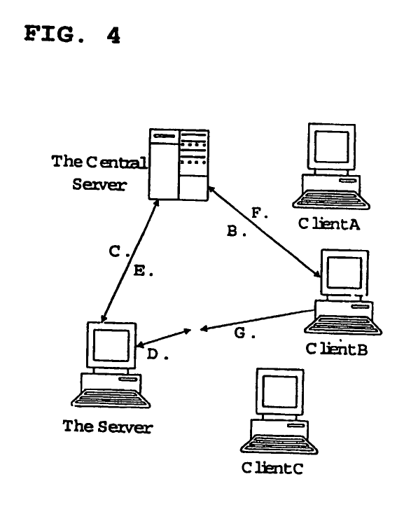

The “non-listening” server mode provides superior security against attacks, since the server never opens a publicly visible port. However, the NLS mode cannot function properly if the clients reside behind a firewall. The Just-In-Time Listening method extends capabilities of the “non-listening” server method to operate in environments where both the server and its Client are behind firewalls or in environments where the Client's information may need to change dynamically. This is accomplished using essentially the same techniques as in the NLS mode, with one exception. Instead of never opening up a publicly visible port to listen, the server opens a temporary listening port for only the time necessary to receive a short encrypted reply from an authorized Client. This temporary listening port will only accept a connection from the one Client that it is waiting on, and it will only wait for a short period of time, preferably under one second. If any other TCP/IP address connects to it during the time the port is open, it will be immediately rejected, the port is closed and the listening halts. If the connection is not properly authorized, the connection is immediately dropped and listening halts. In addition, if the connection is properly authorized, any listening beyond the necessary establishment of a connection also immediately halts. In other words, the connection only ‘listens’ long enough to receive the one request it is awaiting, and immediately stops ‘listening’ after establishing that connection or after an extremely brief timeout period. The coordination of this communication between the server and Client is accomplished through their communication with a central administrative node as illustrated in FIGS. 3 and 4.

Referring to FIG. 3, the server 40 and each of the clients, 60a, 60b and 60c all maintain a persistent or near persistent connection with the central administrative node 50. As in the “Non listening Server” mode, the central administrative node maintains listening ports, which allow the server and other clients to connect to it. Also, as in the previous mode, the central node is addressed preferably by using a domain name, the identity of which the server 40 and all potential clients 60 are aware. Although three clients are shown by way of illustration; any number of clients is possible in this embodiment. In this way, the server and all of the clients are able to communicate with the central node.

Referring to FIG. 4, in step B, client 60b wishes to communicate with the server 40. It communicates this request to the central node 50. In step C, the central node 50 processes this request and sends a command to the server 40 to open a listening port which client 60b will later connect to. The central node 50 prererably transmits identifying information to the server 40 which allows the server to correctly distinguish the requesting client from other devices. This identifying information could be any of a number of items, such as the client's IP address, taken singly or in combination. This disclosure does not limit the type of identifying information that could be used. In step D, the server 50 opens the listening port by sending out a request to the client in question and waiting for a response. In step E, the server 50 communicates to the central node 40 that the listening port is open and that the client should connect. In step F, the central node 40 sends a command to the client 60b to connect to the server 50. Lastly, in step G, the client 60b connects to the server 40 via the temporary listening port. The server ensures that this is the device that it expected to connect. If it is not, the request will be immediately rejected and the listening port closed.

Alternatively, the process can be mode to operate with the client opening the temporary listening port. In this implementation, the client is told by the central node in step F to open a temporary listening port and wait for a response from the server. The request from the server is step D would then be accepted by the client and the secure connection is established.

Additional levels of security can be added to the JITL scenario via encryption technology if desired. For example, the messages exchanged in the JITL, mode can be encrypted, using algorithms and technologies that are known by those skilled in the art.

As described above, the primary advantage of JITL mode over NLS mode is that a server operating in JITL mode has the ability to provide connections when both the server and the Client are behind firewalls. The primary disadvantage of JITL mode is that it must maintain a connection to a central administrative node.

1. A method of operating a computer network server in a network having a central node and wherein said network comprises at least one client authorized to access said computer network server via said central node, said method comprising:
accessing said central node;
obtaining the network addresses of said at least one client;
establishing a computer network connection with said at least one client;
receiving a request from said at least one client over said established connection; and
responding to said request.

2. The method of claim 1, further comprising providing a network device, said network device being selected from the group consisting of firewalls, proxy servers, and network translation devices, said network device being in the path between said server and said network.

3. A method of operating a computer network server in a computer network having a central node wherein said network comprises at least one client authorized to access said server, wherein said server has a listening port, accessible during a predetermined time, comprising:
maintaining a connection with a central node;
receiving a command from said central node to open a listening port after said central node receives a request from said at least one client to access said server;
opening said listening port;
sending to said central node instructions for said client to connect to said server over said listening port; and
receiving communication from said client over said listening port after said central node delivers a command to said at least one client to connect to said server.

4. The method of claim 3, whereby said predetermined time is less than one second.

5. The method of claim 3, whereby said server closes said listening port after receipt of said communication.

6. The method of claim 3, whereby said server establishes a network connection with said client after receipt of said communication.

7. The method of claim 3, whereby said server closes said listening port if it receives communication from other than said at least one client.

8. The method of claim 3, whereby said server maintains a persistent network connection to said central node.

9. The method of claim 3, whereby said command is encrypted.

10. The method of claim 3, whereby said instructions are encrypted.

11. The method of claim 3, whereby said communication is encrypted.

12. A method of sharing data between a server and at least one client authorized to access said data resident on said server on a network using network connections, whereby all said network connections between said server and said at least one client are initiated by said server.

13. The method of claim 12, further comprising a central node, whereby said server requests from said central node a list of said at least one clients authorized to access data resident on said server.

14. The method of claim 13, whereby said request is encrypted.

15. The method of claim 13, whereby said server initiates a network connection to each of said at least one authorized clients.

16. The method of claim 15, whereby said at least one authorized client requests data from said server using said network connection previously initiated by said server.

17. A computer system, comprising a central node, a server and at least one authorized client, wherein said server is adapted to access said central node to obtain a list of said clients authorized to access data on said server.

18. The computer system of claim 17, wherein said server is adapted to establish a network connection to each said at least one authorized client.

19. The computer system of claim 18, wherein said server is adapted to receive a request over said established network connection from said at least one client and is adapted to respond to said request.

20. A computer system, comprising a central node, a server and at least one authorized client, wherein said server is adapted to receive notification from said central node that said authorized client wishes to communicate with said server and in response to said notification, is adapted to open a listening port for said authorized client to connect to and sends instructions to said central node to notify said authorized client to communicate to said listening port.

21. The computer system of claim 20, wherein said server is adapted to close said listening port if a device other than said authorized client attempts to communicate to said listening port.

22. The computer system of claim 20, wherein said server is adapted to establish a network connection with said authorized client after said authorized client communicates to said listening port.

23. The computer system of claim 20, wherein said server is adapted close said listening port after receipt of said communication from said authorized client.

24. A computer program product for instructing a processor in a computer network server in a network having a central node and wherein said network comprises at least one client authorized to access said computer network server via said central node, said computer program product comprising:
a computer readable medium;
first program instruction means for accessing said central node;
second program instruction means for obtaining the network addresses of said at least one client;
third program instruction means for establishing a computer network connection with said at least one client;
fourth program instruction means for receiving a request from said at least one client over said established connection and responding to said request.

25. A computer program product for instructing a processor of a computer network server in a computer network having a central node wherein said network comprises at least one client authorized to access said server, wherein said server has a listening port, accessible during a predetermined time, said computer program comprising:
a computer readable medium;
first program instruction means for maintaining a connection with a central node;
second program instruction means for receiving a command from said central node to open a listening port after said central node receives a request from said at least one client to access said server;
third program instruction means for opening said listening port;
fourth program instruction means for sending to said central node instructions for said client to connect to said server over said listening port; and
fifth program instruction means for receiving communication from said client over said listening port after said central node delivers a command to said at least one client to connect to said server.
